(19) United States
(12) Patent Application Publication
(10) Pub. No.: US 2025/0245583 A1
(43) Pub. Date: Jul. 31, 2025

(54) SYSTEMS AND METHODS FOR GENERATING A SCHEDULE BASED ON PREFERENTIAL CRITERIA

(71) Applicant: Elph AI, LLC, Austin, TX (US)

(72) Inventors: Hunter Chemelli, Austin, TX (US); Josha D. Alexander, Austin, TX (US); Thatcher Thornberry, Denver, CO (US); Brian J. Philpott, Austin, TX (US)

(21) Appl. No.: 19/043,240

(22) Filed: Jan. 31, 2025

Related U.S. Application Data
(60) Provisional application No. 63/627,544, filed on Jan. 31, 2024.

(51) Int. Cl. G06Q 10/0631

(52) U.S. Cl. CPC G06Q 10/063116

(57) ABSTRACT

The present disclosure relates to systems and methods for generating customized schedules based on user preferences and external criteria. The disclosed technology enables automatic or manual collection of user preference data, comparison against an event schedule, and generation of an optimized event itinerary. Applications include, but are not limited to, music festivals, business conventions, and multi-session events. The system utilizes a matching algorithm to compare user preferences with event details, considering factors such as event content, timing, and location constraints. The generated itinerary may be visually presented through a heat map grid, a marked-up digital poster, or other interactive formats. The system also allows for user modifications and iterative refinements based on additional input. Further, the technology may provide related recommendations, such as curated playlists or suggested reading materials, enhancing user engagement. This system improves scheduling efficiency by reducing manual intervention while ensuring schedules are tailored to individual preferences.

### RELATED APPLICATION

This application claims the benefit of U.S. Prov. Pat. App. No. 63/627,544, filed on Jan. 31, 2024. The application referenced in this paragraph is hereby incorporated by reference as if set forth fully herein.

### BACKGROUND OF THE DISCLOSURE

### Field of the Disclosure

The present disclosure relates to scheduling systems and methods. More particularly, it pertains to systems and methods that generate customized schedules and itineraries based on a set of user preferences and external criteria.

### Description of the Related Art

Scheduling systems often rely on manual inputs or rigid templates that do not adequately account for individual preferences or dynamic external factors, such as conflicts in timing or geographical constraints. For example, event-scheduling applications may lack the ability to generate tailored schedules efficiently, requiring extensive user intervention. The present disclosure addresses these and other limitations.

### SUMMARY OF THE DISCLOSURE

The disclosed systems and methods enable the creation of schedules curated from a set of preferential criteria provided by a user or another system. These systems can automatically or manually gather preference data, compare it against a master schedule, and output a recommended schedule tailored to the user's needs and constraints. Applications include, but are not limited to, music festivals, business conventions, and other multi-session events.

### BRIEF DESCRIPTION OF THE DRAWINGS

Figures illustrating various embodiments of the invention, such as graphical user interfaces, algorithmic workflows, and sample outputs, will be described in detail as part of this disclosure.

FIG. 1 is a screenshot of an application interface according to an embodiment of the present disclosure.

FIG. 2 is a screenshot showing a Grid View output from an application interface according to an embodiment of the present disclosure.

FIG. 3 is an exemplary music festival poster.

FIG. 4 is a screenshot showing a Poster View output from an application interface according to an embodiment of the present disclosure.

### DETAILED DESCRIPTION OF THE DISCLOSURE

Embodiments of the present disclosure describe systems and methods for generating a schedule or itinerary (i.e., a scheduling tool or a scheduler) which is curated from a set of preferential criteria. One exemplary application for such systems and methods is a software application that curates a schedule for performances at a music festival (e.g., Austin City Limits Music Festival, Bonaroo, or Coachella), wherein the recommended performances are selected based on a user's musical preferences and, optionally, logistical considerations. The data used to curate the recommended schedule may be manually provided, such as by entering a list of the user's favorite artists, songs, albums, etc., or it may be entered automatically, for example, by importing the user's preferences from a music streaming service, such as Spotify, Pandora, and Apple Music.

Although this exemplary application of curating a music festival schedule is referenced throughout the present disclosure, it is understood that many other applications are possible. For example, in another application, a business convention attendee may have a recommended session schedule curated from a set of the attendee's preferences. Again, the preference data may be provided by manual entry, such as a set of questions presented to the attendee upon registration, or it can be provided automatically, for example, by linking the application to an attendee's LinkedIn profile.

Throughout this description, preferred embodiments and examples illustrated should be considered as exemplars, rather than as limitations on the present invention. As used herein, the term “invention,” “device,” “method,” “disclosure,” “present invention,” “present device,” “present method,” or “present disclosure” refers to any one of the embodiments of the invention described herein, and any equivalents. Furthermore, reference to various feature(s) of the “invention,” “device,” “method,” “disclosure,” “present invention,” “present device,” “present method,” or “present disclosure” throughout this document does not mean that all claimed embodiments or methods must include the referenced feature(s).

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc., may be used herein to describe various elements, components, or steps, these elements, components, or steps should not be limited by these terms. These terms are only used to distinguish one element, component, or step from another element, component, or step. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

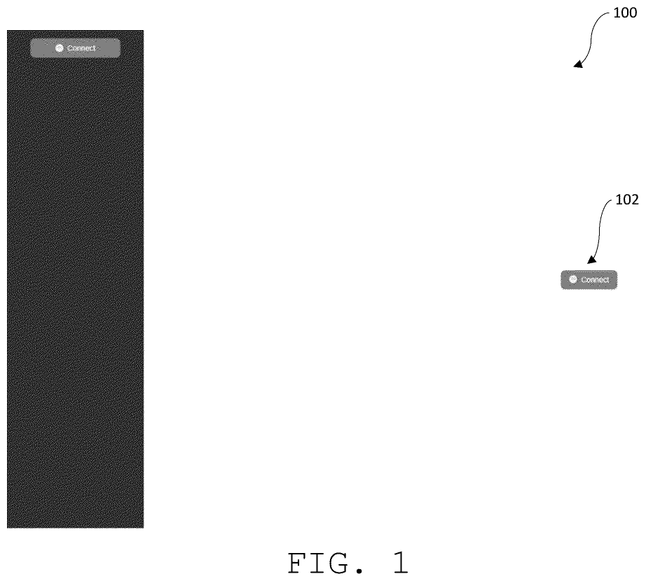

In one application of the disclosed systems/methods designed to provide a user with a curated schedule for a music festival, the user may interact with mobile application. The user can initiate the mobile application at which point that user is prompted to either manually enter a set of seed data by, for example, answering a series of questions, or the seed data may be provided automatically, for example, by logging into a music streaming service. FIG. 1 is a screenshot 100 from an application interface according to an embodiment of the present disclosure. As shown in the screenshot 100, a user may be prompted to link the application to another service using the “Connect” button 102, in this example, the user's Spotify account.

After pressing the “Connect” button 102, the user is redirected to the login screen for a music streaming service, for example, Spotify. The user may then log in to the service by entering the user's credentials or otherwise authenticating. Once the user has logged in, the application reads in a set of related to the user's preferences. This user preference data set is then compared against event data from an event schedule, such as a master performance schedule, using a matching algorithm, for example. Event data may include substantive event data (e.g., the name of a performer, the title of a presentation, etc.) or logistical event data (e.g., event location, event time, etc.). Based at least partially on a comparison of the event data and the user preference data and/or user input, the algorithm compiles a recommended event itinerary for the user. In this particular embodiment, the event itinerary includes artists that the user would prefer based on the user's imported playlist history (and/or other imported data) as predicted by the algorithm.

As noted, the event itinerary may also be based on additional criteria unrelated to the user's preferences, e.g., logistical data. In one embodiment, the schedule may be created such that no overlapping performances are recommended, or the schedule may allow for overlap within a set tolerance (e.g., fifteen (15) minutes or less) such that performances by artists that are indicated as high priority may be included in the schedule even though the performances overlap temporally. The event itinerary may also be generated in view of other criteria, such as event location (e.g., the physical location of stages) such that event location proximity and travel time between events may be considered. For example, if a recommended performance on Stage A is back-to-back with a recommended performance on Stage Z, and Stage A is one mile from Stage Z, then the scheduler may not include both performances on the event itinerary.

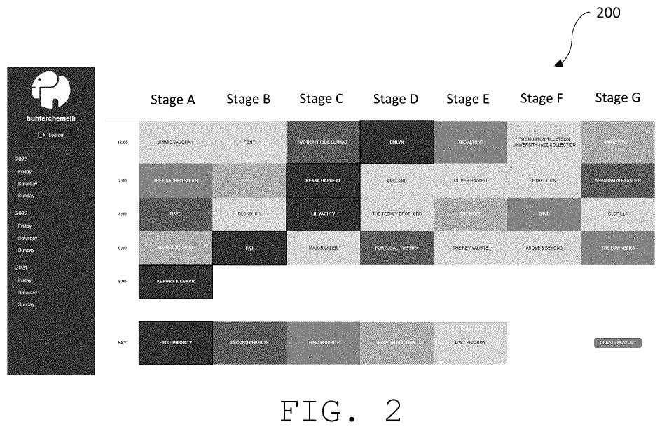

Once the event itinerary has been compiled, the schedule may be output to the user. In some embodiments, the output is in a visual format. The information may be presented visually in various ways that are pleasing to the user. For example, the recommended schedule may appear as a time grid with the recommended performances provided in a color code (i.e., in “Grid View”), as shown in FIG. 2. The information may be presented on a computer screen or a mobile device screen, for example.

FIG. 2 is a screenshot 200 showing a Grid View output from an application interface according to an embodiment of the present disclosure. In this particular example, the event itinerary (here, a musical performance schedule) is shown as a grid with the event location (i.e., Stage A to Stage G) shown along the horizontal axis and the event timeslot shown along the vertical axis. Here, the application indicates the recommended performances by color-coding the grid, with the recommended performances that scored the highest based on the user's preferences, user input, and other algorithm criteria (i.e., highest priority) shown in dark blue. Lower priority performances are shown in increasingly lighter shades of blue. In this example, a legend 304 has been provided at the bottom of the grid for easy reference by the user. This kind of visual display of data is sometimes referred to as a “heat map” grid. The application may allow the user to tailor the output to any desired color-code specification.

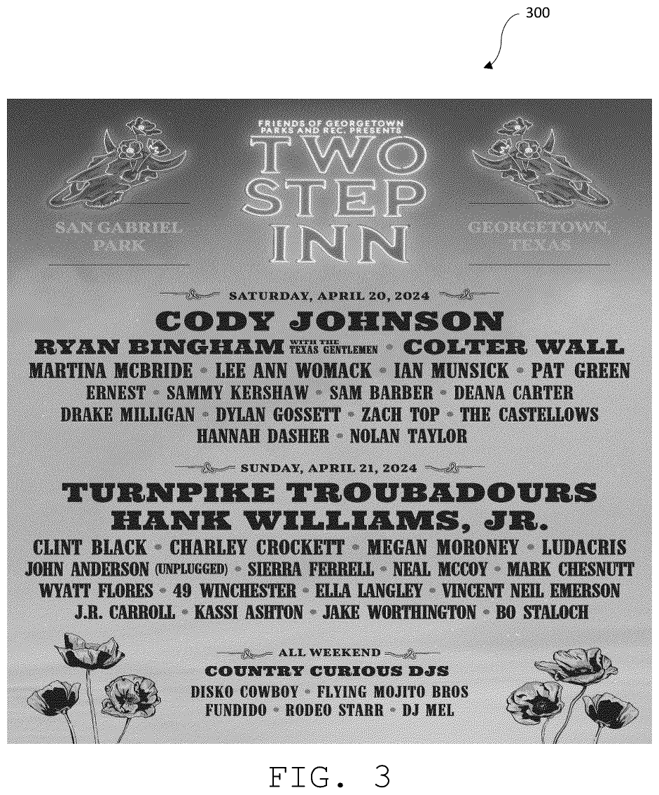

It is understood that the output may be provided in various other visual formats and, indeed, in non-visual formats, such as an audio read-out. For example, many music festivals use posters, both digital and paper, to advertise the festival lineup. An example of such a poster is shown in FIG. 3.

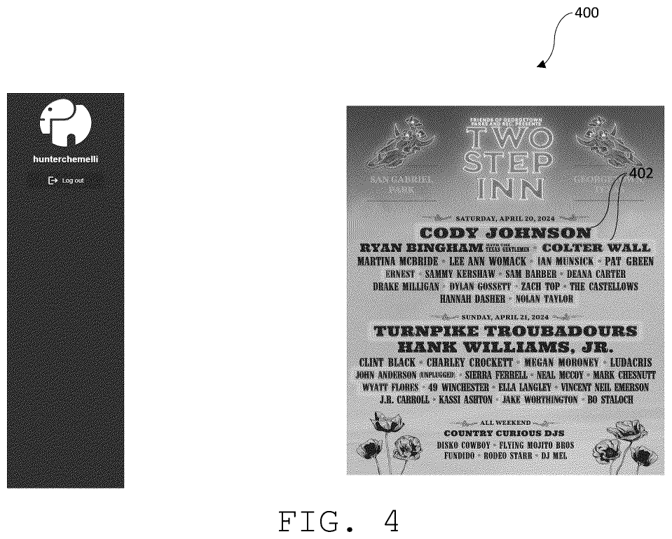

FIG. 3 is an exemplary music festival poster 300, which is provided for comparative purposes. This particular poster was published and distributed digitally in connection with the 2024 Two Step Inn music festival. Many similar digital posters are periodically published in connection with such festivals and other kinds of gatherings. In one embodiment of a scheduling system/method, the visual output is presented as a marked-up version of a digital festival poster (i.e., in “Poster View”), as shown in FIG. 4.

FIG. 4 is a screenshot 400 showing a Poster View output from an application interface according to an embodiment of the present disclosure. In this particular example, the event itinerary indicates the recommended performances with boxes 402 outlining the associated artists. Here, the user can toggle back and forth between the marked-up poster (Poster View) and the heat map grid (Grid View). It is also possible to include color-coding in Poster View such that higher priority shows are boxed or highlighted in various colors or shades to indicate priority.

In some embodiments, it is possible for the user to interact with the event itinerary after it has been generated to further tailor and customize it through iterative refinement. For example, if a user does not want to attend a particular event, that event may be de-selected, which can prompt the scheduler to run the comparison/algorithm again and compile a revised event itinerary that does not include the de-selected event. The de-selection may also be used to logistically adjust the revised event itinerary based on the new availability of the timeslot of the de-selected event, for example, or the de-selection can be taken into account by the algorithm to refine the prediction of the user's preferences substantively.

In some embodiments, it would also be possible for the user to manually select performances that were not recommended by the scheduler. Similarly, as with de-selection, the scheduler can provide a revised itinerary, which accounts for the manual selection either logistically or substantively.

In some embodiments of the scheduling system/method, the application may be able to utilize the data comparison and/or user input data to provide related additional functionality, including recommendations. In one embodiment, the system/method can provide additional information related to the subject matter of the recommended events from the event itinerary. For example, based on the output event itinerary for a music festival, the application can provide a curated playlist that includes the artists, or similar artists, associated with the recommended performance schedule. Such a playlist might include, for example, the current five most popular songs from each artist that is indicated as high priority on the recommended performance schedule. That playlist can then be exported back into a streaming service, such as Spotify, for immediate playback. This is especially desirable for users that want familiarity with the artists and their songs that are likely to be played prior to seeing a performance. Similarly, in the context of a business conference, based on the comparison data and/or user input data, a recommended reading list can be generated to provide the user with additional materials associated with the subject matter of the recommended events.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present disclosure has been described in detail with reference to certain preferred configurations thereof, other versions are possible. Embodiments of the present disclosure can comprise any combination of compatible features shown in the various figures, and these embodiments should not be limited to those expressly illustrated and discussed. Therefore, the spirit and scope of the disclosure should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the disclosure.

We claim:

1. A method for generating a customized schedule of events, comprising:
receiving an event schedule comprising event data;
extracting at least some of said event data from said event schedule;
receiving user preference data related to said event data;
comparing said event data to said user preference data to provide a data comparison;
based on said data comparison, compiling an event itinerary; and
outputting said event itinerary in a visual format.

2. The method of claim 1, further comprising:
receiving user input from a user related to said event itinerary;
based on said user input and said data comparison, compiling a revised event itinerary; and
outputting said revised event itinerary in a visual format.

3. The method of claim 1, wherein said event data comprises logistical data comprising event times and event locations and substantive data comprising event descriptions, and wherein said substantive data is considered in said data comparison and said logistical data is considered when compiling said event itinerary.

4. The method of claim 1, wherein said event schedule comprises a music festival schedule.

5. The method of claim 1, wherein said event schedule comprises a conference schedule.

6. The method of claim 1, wherein said visual format comprises a heat map grid.

7. The method of claim 1, wherein said visual format comprises a marked-up digital poster.

8. The method of claim 1, wherein said user preference data is received from a user account on a third-party system.

9. The method of claim 1, wherein said user preference data is received directly from a user.

10. The method of claim 1, further comprising:
generating additional information that is related to the subject matter of said event data based on said event itinerary.

11. A system for generating a customized schedule of events, comprising:
a extraction module configured to extract event data from an event schedule;
a data acquisition module configured to receive and store said event data and related user preference data;
a processor configured to compare said event data and said user preference data to provide a data comparison;
a scheduling engine configured to generate an event itinerary based on said data comparison; and
an output module configured to present said event itinerary in a visual format.

12. The system of claim 11, further comprising:
an input module configured to receive user input;
wherein said user input and said data comparison are used by said scheduling engine to generate a revised event itinerary.

13. The system of claim 11, wherein said output module comprises a mobile device.

14. The system of claim 11, wherein said event schedule comprises a music festival schedule.

15. The method of claim 11, wherein said event schedule comprises a conference schedule.

16. A non-transient computer readable medium containing program instructions for causing a computer to perform the method comprising the following steps:
receiving an event schedule comprising event data;
extracting at least some of said event data from said event schedule;
receiving user preference data related to said event data;
comparing said event data to said user preference data to provide a data comparison;
based on said data comparison, compiling an event itinerary; and
outputting said event itinerary in a visual format.

17. The non-transient computer readable medium of claim 16, further comprising:
receiving user input from a user related to said event itinerary;
based on said user input and said data comparison, compiling a revised event itinerary; and
outputting said revised event itinerary in a visual format.

18. The non-transient computer readable medium of claim 16, wherein said visual format comprises a heat map grid.

19. The non-transient computer readable medium of claim 16, wherein said visual format comprises a marked-up digital poster.
